(19) United States
(12) Patent Application Publication
(10) Pub. No.: US 2011/0095995 A1
(43) Pub. Date: Apr. 28, 2011

(54) Infrared Touchscreen for Rear Projection Video Control Panels

(75) Inventors: Mahendra S. Dassanayake, Bloomfield Hills, MI (US); Donald P. Bilger, Livonia, MI (US)

(73) Assignee: FORD GLOBAL TECHNOLOGIES, LLC, Dearborn, MI (US)

(21) Appl. No.: 12/605,705

(22) Filed: Oct. 26, 2009

(51) Int. Cl. G06F 3/041; H04N 9/31

(52) U.S. Cl. 345/173; 348/744; 348/E09.025

(57) ABSTRACT

A control panel system has a projection screen with an inside surface for being illuminated to produce a graphical display and with an outside surface accessible to a user. An illumination source projects radiation to illuminate the projection screen, wherein the radiation includes visible radiation and infrared radiation. An optical distribution system distributes the visible radiation according to an image for the graphical display and distributes the infrared radiation according to a predetermined pattern, wherein the projection screen transmits the infrared radiation out from the outside surface where it can be reflected back toward the optical distribution system by a manually-controlled object that is placed by the user in relation to the image. An infrared sensor receives the reflected infrared radiation from the optical distribution system and generates a detection signal identifying the location of the manually-controlled object in response to the predetermined pattern.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to touchscreen display panels, and, more specifically, to providing touchscreen controls for a rear projection display especially for motor vehicles.

Control panels having a video screen for displaying graphic/text data and having touch detectors for sensing user input are often used in the “center stack” or dashboard of motor vehicles. Various vehicle systems such as a climate control system or an audio system may be coupled to and controlled by the control panel. In a typical construction, a display screen is combined with resistive or capacitive touchscreens in a single integrated unit. Such conventional control panels have limited form factors and cannot easily support desirable styling features such as a compound curvature. For example, neither the commonly used LCD display units nor commonly used resistive or capacitive touchscreens are able to conform to a rounded shape of a center stack.

In order to create an attractively styled control panel and display interface in the center stack, rear video projection onto a complex-curved screen has been suggested. However, the capacitive or resistive touchscreen overlays only support at most one axis of curvature. Furthermore, conventional touchscreen overlays undesirably attenuate the brightness of the projected image which must pass through the overlay.

### SUMMARY OF THE INVENTION

The present invention provides an advantageous touchscreen display panel capable of complex curvatures without reducing the brightness of the display.

In one aspect of the invention, a control panel system comprises a projection screen having an inside surface for being illuminated to produce a graphical display and having an outside surface accessible to a user. An illumination source projects radiation to illuminate the projection screen, wherein the radiation includes visible radiation and infrared radiation. An optical distribution system distributes the visible radiation according to an image for the graphical display and distributes the infrared radiation according to a predetermined pattern, wherein the projection screen transmits the infrared radiation out from the outside surface where it can be reflected back toward the optical distribution system by a manually-controlled object that is placed by the user in relation to the image. An infrared sensor receives the reflected infrared radiation from the optical distribution system and generates a detection signal identifying the location of the manually-controlled object in response to the predetermined pattern.

### BRIEF DESCRIPTION OF THE DRAWINGS

FIG. 1 is a schematic view of one embodiment of an optical and electrical system of the present invention.

FIG. 2 is a front view of an image on a projection screen.

FIG. 3 is a plan view of an infrared filter on a projection lens according to one preferred embodiment.

FIG. 4 is a side, cross section of the projection lens and filter along line 4-4 of FIG. 3.

FIG. 5 is a plot showing infrared intensity at various hot spots created by an infrared filter.

FIG. 6 is a plan view of an infrared filter on a mirror according to another preferred embodiment.

FIG. 7 is a plot showing infrared intensity at various points across an image.

FIGS. 8-10 are plots showing infrared intensity at respective times as an infrared emission is scanned across an image in yet another preferred embodiment.

### DETAILED DESCRIPTION OF PREFERRED EMBODIMENTS

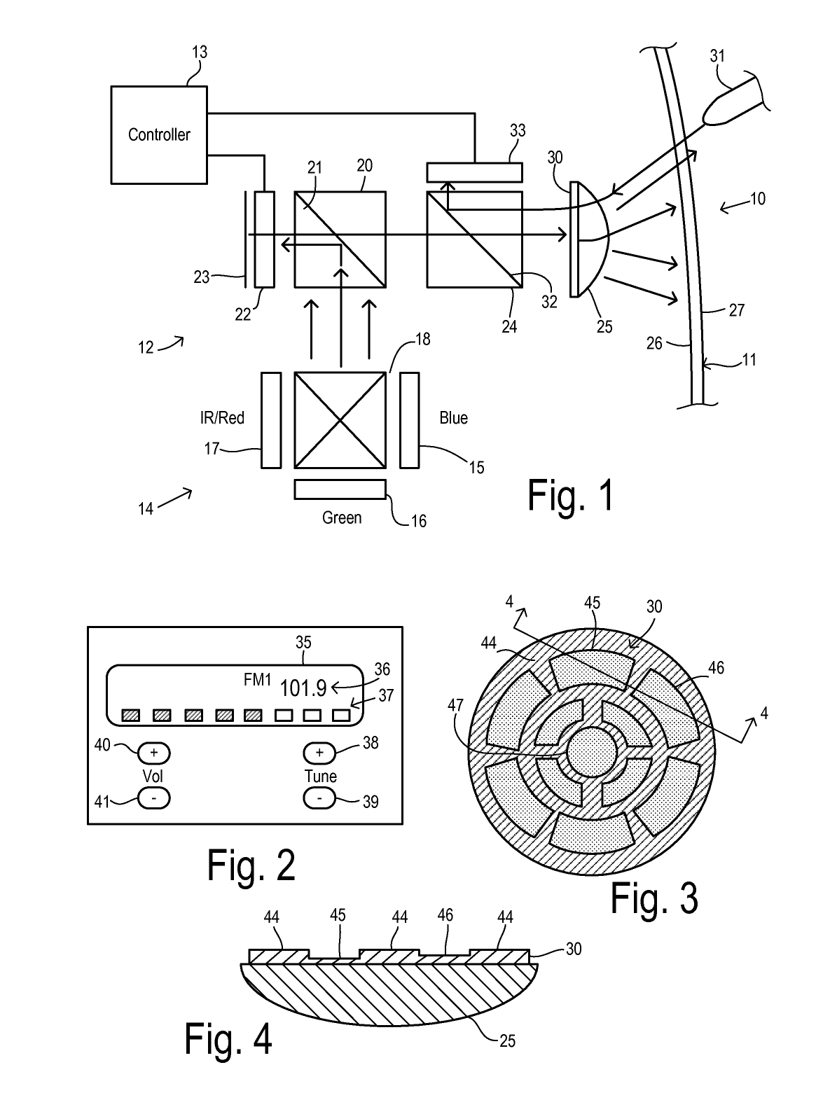

Referring now to FIG. 1, a control panel system 10 includes a rear projection screen 11 which may have a compound shape (i.e., multi-axis curvature) and is formed of conventional materials such as those conventionally used in rear projection televisions, such as glass, polycarbonate, or acrylic. A rear projection optical distribution system 12 operates under control of a controller 13 to create an image to be graphically displayed to a user. Controller 13 further senses placement of the user's finger (or other manually-controlled object) at any particular position along the outside surface of screen 11. The user obtains a desired action by placing their finger proximate to a particular portion of the image that will be correlated by controller 13 to a predefined action as represented within the displayed image.

In accordance with the present invention, optical distribution system 12 projects visible radiation to create the image and projects infrared radiation and receives reflected infrared radiation to perform the touchscreen function.

An illumination source 14 includes a blue LED source 15, a green LED source 16, and an infrared/red LED source 17. The LEDs direct their radiation into a corner cube 18 for combining and collimating the visible and infrared radiation components toward a corner cube 20. Corner cube 20 includes an internal surface 21 that redirects the radiation from corner cube 18 to an image former 22 and a backing mirror 23. Image former 22 is coupled to controller 13 and may comprise a pixilated LCD device as known in the art. Image former 22 attenuates red, green, and blue light according to pixels in the desired image to be projected. The remaining light reflects off of mirror 23 back through corner cube 20 and through another corner cube 24 to a projection lens 25.

The visible light image projected from lens 25 illuminates an inside surface 26 of screen 11. Screen 11 defuses the light of the image as it passes through to an outside surface 27 so that the projected image is visible over a wide range of viewing angles from the outside of screen 11.

While certain portions of the visible radiation are blocked to form the image, all the components of the optical system 12 discussed up to this point are substantially transparent to the infrared radiation (i.e., they would provide substantial uniformity of the infrared radiation across the graphical display). In one preferred embodiment, deviations in the infrared intensity across the graphically display are introduced by an optical element such as an infrared filter element 30 which will enable localization of touchscreen actions as described in greater detail below.

The infrared radiation passing through projection lens 25 illuminates the projection screen which is substantially transparent to the infrared radiation so that it passes through to the outside of screen 11 where it can be reflected back toward optical distribution system 12 by a user's finger 31 or another manually-controlled object placed by the user proximate to the image on projection screen 11 to achieve a desired input to controller 13. More particularly, infrared radiation reflects back from finger 31 toward projection lens 25 and corner cube 24. An internal surface 32 in corner cube 24 reflects the infrared radiation toward an infrared sensor 33 which generates a detection signal that identifies the location of object 31. The detection signal is provided to controller 13 which may communicate the user's input to an appropriate control module for implementing the corresponding action identified by the user.

As shown in FIG. 2, the image on the graphical display may correspond to an audio system control having a radio display 35. A radio frequency display 36 is shown with a volume setting display 37. The image includes tuning adjustment icons 38 and 39 and volume adjustment icons 40 and 41. According to the present invention, the locations of icons 38-41 in the visible image correspond to respective regions in a predetermined pattern of the infrared radiation to be reflected to the infrared sensor in a manner allowing detection of the location of the reflecting object. The location is correlated with the desired function, such as raising or lowering the tuner frequency or raising or lowering the audio system volume.

As mentioned above, optical distribution system 12 distributes the visible radiation according to an image for the graphical display and distributes the infrared radiation according to a predetermined pattern. The predetermined pattern according to one preferred embodiment of the invention is comprised of a plurality of regions that are spatially separated across the graphically display wherein the regions each have a respective unique intensity of infrared radiation. Accordingly, the detection signal has a scalar value uniquely correlated to a particular region where the infrared radiation is being reflected from (i.e., the location where the user's finger is placed). In one preferred embodiment, the predetermined pattern may be generated using infrared filter 30 which variably attenuates the infrared radiation to define the various regions while being substantially transparent to visible radiation. As shown in FIGS. 3 and 4, infrared filter element 30 is deposited on a flat inside surface of projection lens 25 typically using a multi-layer coating formed of dielectric thin films. The multi-layer coating may create the desired regions or hot spots by incorporating different coating compositions or different thicknesses to achieve the variable infrared attenuation. FIG. 4 illustrates various thicknesses wherein substantially full cut-off of infrared radiation is obtained at regions 44 and variable infrared intensity passes through regions 45 and 46 to generate respective hot spots for producing distinguishable return reflections from the user's finger. As shown in plan view in FIG. 3, the variable intensity associated with a particular hot spot region can also be obtained by differences in the surface area associated with each hot spot (such as a reduced area region 47 at the center).

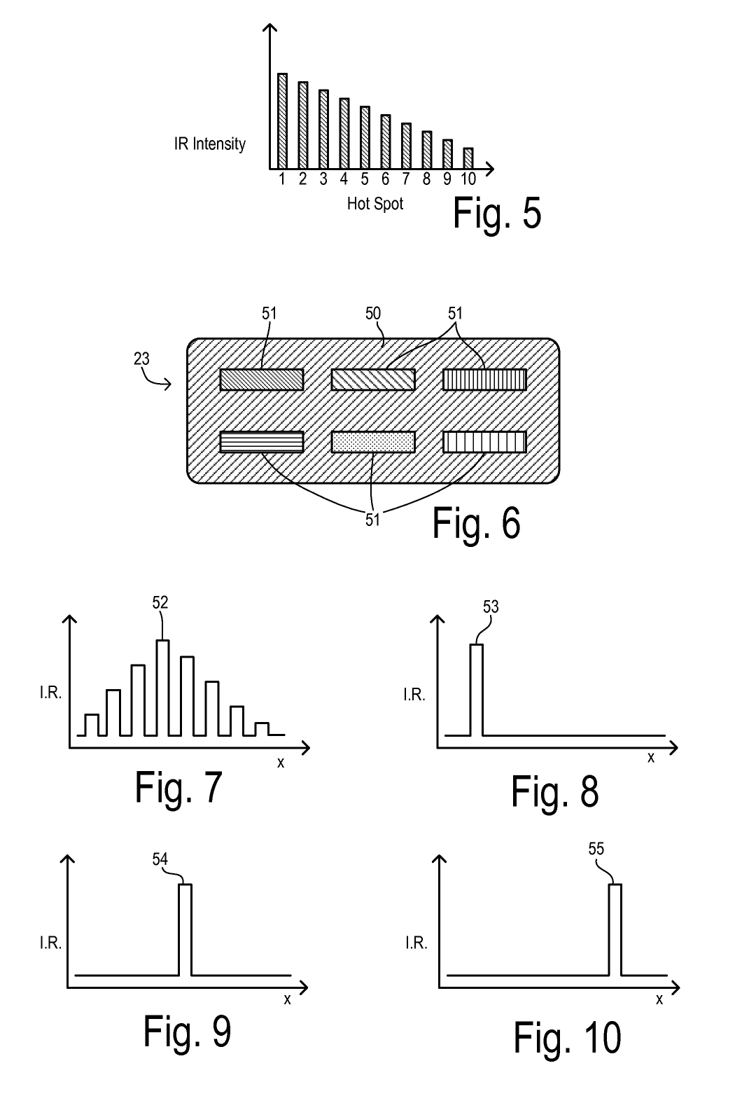

FIG. 5 shows the variable infrared intensity that may be associated with a plurality of infrared hot spots #1-#10 placed across the visible light image. By detecting the intensity of the reflected infrared, the region at which the reflection occurs can be identified. Infrared sensor 33 in FIG. 1 may preferably be comprised of an infrared detector such as the Halios® optoelectronic sensor available from Elmos Semiconductor AG of Dortmund, Germany. The Halios® detector can be configured to generate an output signal having a scalar magnitude value representative of the infrared intensity of the received reflection signal. The controller maps the scalar magnitude to corresponding region and translates the identified region to the corresponding control function (e.g., adjusting the temperature of the climate control system).

In alternate embodiments, the infrared attenuating pattern can be deposited on another optical element such as the reflecting mirror, one of the corner cubes, the projection screen, or on a separate flat film or glass plate placed in the light path. FIG. 6 shows mirror 23 having a multi-layer coating 50 deposited thereon to provide full cutoff of infrared radiation except in spatially separated regions 51. Each region 51 provides a unique infrared intensity. FIG. 7 shows infrared intensity at different positions x across the graphical display. Each peak in intensity such as a central peak 52 corresponds to a respective region 51 of FIG. 6 and can be used to uniquely identify the placement of the user's finger on the touchscreen as already explained.

In an alternative embodiment, the optical system can be modified to provide infrared radiation that varies with time. Thus, an area of localized infrared radiation may be scanned through a plurality of regions that are spatially separated across the graphical display, wherein the time when the detection signal occurs identifies the particular region where the user's finger is placed. As shown in FIGS. 8-10, an infrared peak 53 occurs at a first position on the visible image at a first time, an infrared peak 54 occurs at a second position at a second time, and a peak 55 occurs at a third position at a third time. Each peak is produced at a different one of the spatially separated regions at a different time, which is synchronized with the controller so that the position of the reflecting object can be determined.

After controller 13 in FIG. 1 determines the particular region where the infrared reflection occurs and associates that region to a particular function identified within the visible image, a corresponding command or data may be sent by controller 13 to the appropriate accessory or other electronic controller in the vehicle to allow the selective function to be carried out.

What is claimed is:

1. A control panel system comprising:
a projection screen having an inside surface for being illuminated to produce a graphical display and having an outside surface accessible to a user;
an illumination source for projecting radiation to illuminate the projection screen, wherein the radiation includes visible radiation and infrared radiation;
an optical distribution system for distributing the visible radiation according to an image for the graphical display and for distributing the infrared radiation according to a predetermined pattern, wherein the projection screen transmits the infrared radiation out from the outside surface where it can be reflected back toward the optical distribution system by a manually-controlled object that is placed by the user in relation to the image; and
an infrared sensor receiving the reflected infrared radiation from the optical is distribution system and generating a detection signal identifying the location of the manually-controlled object in response to the predetermined pattern.

2. The system of claim 1 wherein the predetermined pattern is comprised of a plurality of regions that are spatially separated across the graphical display, wherein the regions each have a respective unique intensity of infrared radiation, and wherein the detection signal has a scalar value uniquely correlated to a particular region where the manually-controlled object is placed.

3. The system of claim 1 wherein the predetermined pattern is comprised of localized infrared radiation that is scanned through a plurality of regions that are spatially separated across the graphical display, and wherein the time when the detection signal occurs identifies a particular region where the manually-controlled object is placed.

4. The system of claim 1 wherein the optical distribution system comprises an infrared filter element having variable infrared attenuation corresponding to the plurality of regions.

5. The system of claim 4 wherein the optical distribution system comprises a projection lens, and wherein the infrared filter element is deposited on a surface of the projection lens.

6. The system of claim 4 wherein the optical distribution system comprises a mirror, and wherein the infrared filter element is deposited on a surface of the mirror.

7. The system of claim 1 wherein the illumination source is comprised of a plurality of light emitting diodes.

8. A method of detecting manual user input on a projection touchscreen display panel, comprising the steps of:
projecting a visible image from an optical distribution system onto an inside surface of a projection screen, wherein the projection screen has an outside surface accessible to a user;
projecting infrared radiation from the optical distribution system in a predetermined pattern over the visible image, wherein the projection screen transmits the infrared radiation out from the outside surface;
manually placing an object proximate to the image to reflect a portion of the infrared radiation back toward the optical distribution system; and
sensing the reflected infrared radiation in the optical distribution system to generating a detection signal identifying the location of the manually-controlled object in response to the predetermined pattern.

9. The method of claim 8 wherein the step of projecting the infrared radiation from the optical distribution system comprises passing the infrared radiation through an infrared filter having a variable attenuation corresponding to the predetermined pattern, wherein the predetermined pattern has a plurality of regions that are spatially separated across the image, wherein the regions each have a respective unique intensity of infrared radiation, and wherein the detection signal has a scalar value uniquely correlated to a particular region where the manually-controlled object is placed.

10. The method of claim 8 wherein the step of projecting the infrared radiation from the optical distribution system comprises scanning the infrared radiation through a plurality of regions that are spatially separated across the image, and wherein the time when the detection signal occurs identifies a particular region where the manually-controlled object is placed.
